(19) United States
(12) Patent Application Publication
(10) Pub. No.: US 2018/0210541 A1
(43) Pub. Date: Jul. 26, 2018

(54) METHOD AND APPARATUS FOR DYNAMIC CONTROL OF SENSORS TO ENHANCE SECURITY

(71) Applicant: QUALCOMM Incorporated, San Diego, CA (US)

(72) Inventors: Atul Soni, Hyderabad (IN); Ankit Maheshwari, Hyderabad (IN); Omprakash Todarwal, Yavatmal (IN)

(21) Appl. No.: 15/413,177

(22) Filed: Jan. 23, 2017

(51) Int. Cl. G06F 3/01; G06F 1/16; G06F 3/0346

(52) U.S. Cl. CPC G06F 3/011; G06F 3/0488; G06F 3/0346; G06F 1/163

(57) ABSTRACT

In an aspect, a wearable apparatus obtains information indicating that a user of the wearable apparatus is to input secure information (e.g., a personal identification number (PIN)). The wearable apparatus disables, in response to the obtained information, one or more sensors of the wearable apparatus that are capable of tracking hand movements of the user. For example, disabling the one or more sensors of the wearable apparatus prevents the one or more sensors from generating sensor data that can comprise the secure information. In an aspect, the wearable apparatus enables the one or more sensors of the wearable apparatus when the user has completed the input of the secure information, when the user is no longer proximate to a secure data entry point, or when a signal indicating to enable the one or more sensors of the wearable apparatus is received from a client apparatus.

### INTRODUCTION

### Field of the Disclosure

Aspects of the disclosure relate generally to a method and apparatus for dynamic control of sensors to enhance security.

### BACKGROUND

Wearable devices (e.g., a smartwatch, a fitness tracking device) typically include embedded sensors, such as accelerometers and/or gyroscopes, that track the user's movements. However, these embedded sensors may also capture the hand movements of the user as she enters secure information (e.g., a personal identification number (PIN), user name, etc.) at a secure information entry point, such as a keypad of a cash machine (also referred to as an automated teller machine (ATM)). An unauthorized user, such as a hacker, may obtain the sensor data indicating the hand movements of the user of the wearable device to determine the secure information input by the user of the wearable device. For example, the unauthorized user may use the sensor data to steal a PIN (e.g., for an ATM or digital wallet) of a user. Unauthorized users may also monitor sensor data for other secure transactions as well to determine specific and private information about the user of the wearable device. For example, parsing algorithms may be applied to the sensor data to determine the patterns and personal details associated with a user. In addition, since client devices (e.g., smartphones) are being used for a variety of mobile transactions that involve the input of secure information by the user, and given that sensor data collected on a wearable device may be continuously shared with client devices, any secure information (or personal information) of a user may be inadvertently shared or revealed upon a security breach on the wearable device and/or the client device. Conventional wearable devices lack the security features needed to prevent or guard against the previously described forms of information theft.

### SUMMARY

The following presents a simplified summary of some aspects of the disclosure to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

In an aspect, a method for an apparatus is provided. The apparatus may obtain information indicating that a user of the wearable apparatus is to input secure information. The apparatus may disable, in response to the obtained information, one or more sensors of the wearable apparatus that are capable of tracking hand movements of the user. In an aspect, the apparatus may obtain the information by obtaining a location of the user and determining whether the location of the user is proximate to a secure data entry point. In such aspect, the one or more sensors of the wearable apparatus are disabled when the location of the user is proximate to the secure data entry point. In an aspect, the apparatus may determine whether the location of the user is proximate to the secure data entry point by obtaining a distance between the location of the user and each of a set of locations of secure data entry points stored at the wearable apparatus, and determining that the location of the user is proximate to the secure data entry point when the distance is less than a threshold value. In an aspect, the apparatus may obtain the information by receiving a signal from a client apparatus when the user attempts to input the secure information through an interface on the client apparatus, wherein the signal indicates to disable the one or more sensors of the wearable apparatus. For example, the signal from the client apparatus may be received in response to an initiation of a mobile banking application or a digital wallet application on the client apparatus. In an aspect, the apparatus may obtain the information by receiving a signal from a client apparatus indicating that the user of the wearable apparatus is to input secure information. In an aspect, the apparatus may be further configured to enable the one or more sensors of the wearable apparatus when the user has completed the input of the secure information, when the user is no longer proximate to a secure data entry point, or when a signal indicating to enable the one or more sensors of the wearable apparatus is received from a client apparatus. In an aspect, the one or more sensors of the wearable apparatus includes at least one of an accelerometer device or a gyroscope device. In an aspect, the client apparatus is a portable electronic device that is in communication with the wearable apparatus and that includes an interface for entry of the secure information by the user. In an aspect, the disabling the one or more sensors of the wearable apparatus prevents the one or more sensors from generating sensor data indicating the hand movements of the user during entry of the secure information.

In an aspect, an apparatus is provided. The apparatus may include means for obtaining information indicating that a user of the wearable apparatus is to input secure information. The apparatus may further include means for disabling, in response to the obtained information, one or more sensors of the wearable apparatus that are capable of tracking hand movements of the user. In an aspect, the means for obtaining the information may be configured to obtain a location of the user and determine whether the location of the user is proximate to a secure data entry point. In such aspect, the one or more sensors of the wearable apparatus are disabled when the location of the user is proximate to the secure data entry point. In an aspect, the means for obtaining the information may be configured to determine whether the location of the user is proximate to the secure data entry point by obtaining a distance between the location of the user and each of a set of locations of secure data entry points stored at the wearable apparatus, and determining that the location of the user is proximate to the secure data entry point when the distance is less than a threshold value. In an aspect, the means for obtaining the information may be configured to receive a signal from a client apparatus when the user attempts to input the secure information through an interface on the client apparatus, wherein the signal indicates to disable the one or more sensors of the wearable apparatus. For example, the signal from the client apparatus may be received in response to an initiation of a mobile banking application or a digital wallet application on the client apparatus. In an aspect, the means for obtaining the information may be configured to receive a signal from a client apparatus indicating that the user of the wearable apparatus is to input secure information. In an aspect, the apparatus may further include means for enabling the one or more sensors of the wearable apparatus when the user has completed the input of the secure information, when the user is no longer proximate to a secure data entry point, or when a signal indicating to enable the one or more sensors of the wearable apparatus is received from a client apparatus. In an aspect, the one or more sensors of the wearable apparatus includes at least one of an accelerometer device or a gyroscope device. In an aspect, the client apparatus is a portable electronic device that is in communication with the wearable apparatus and that includes an interface for entry of the secure information by the user. In an aspect, disabling the one or more sensors of the wearable apparatus prevents the one or more sensors from generating sensor data indicating the hand movements of the user during entry of the secure information.

In an aspect, a method for a client apparatus is provided. The client apparatus may establish a communication link with a wearable apparatus, obtain information indicating that a user of the wearable apparatus is to input secure information through an interface on the client apparatus, and may transmit a signal to the wearable apparatus that indicates to disable one or more sensors of the wearable apparatus capable of tracking hand movements of the user. In an aspect, the client apparatus may obtain the information indicating that the user of the wearable apparatus is to input the secure information through the interface on the client apparatus by detecting an initiation of a mobile banking application or a digital wallet application at the client apparatus. In an aspect, the client apparatus is further configured to transmit a signal to the wearable apparatus indicating to enable the one or more sensors of the wearable apparatus when the user has completed the input of the secure information or when one or more secure transactions have been completed.

In an aspect, a client apparatus is provided. The client apparatus may include means for establishing a communication link with a wearable apparatus, means for obtaining information indicating that a user of the wearable apparatus is to input secure information through an interface on the client apparatus, and means for transmitting a signal to the wearable apparatus that indicates to disable one or more sensors of the wearable apparatus capable of tracking hand movements of the user. In an aspect, the means for obtaining the information indicating that the user of the wearable apparatus is to input the secure information through the interface on the client apparatus is configured to detect an initiation of a mobile banking application or a digital wallet application at the client apparatus. In an aspect, the client apparatus further includes means for transmitting a signal to the wearable apparatus indicating to enable the one or more sensors of the wearable apparatus when the user has completed the input of the secure information or when one or more secure transactions have been completed.

These and other aspects of the disclosure will become more fully understood upon a review of the detailed description, which follows. Other aspects, features, and implementations of the disclosure will become apparent to those of ordinary skill in the art, upon reviewing the following description of specific implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. In similar fashion, while certain implementations may be discussed below as device, system, or method implementations it should be understood that such implementations can be implemented in various devices, systems, and methods.

### BRIEF DESCRIPTION OF THE DRAWINGS

FIG. 1 illustrates an example of a conventional wearable device (also referred to as a wearable computing device or a wearable apparatus).

FIG. 2 illustrates an example scenario in which sensor data output from one or more sensors of the conventional wearable device may be received by unauthorized parties to obtain secure information of a user.

FIG. 3 (including FIGS. 3A to 3E) illustrates an example scenario of secure information entry by a user of a conventional wearable device.

FIG. 4 illustrates a block diagram of an example wearable device in accordance with various aspects of the present disclosure.

FIG. 5 (including FIG. 5A and FIG. 5B) illustrates a scenario where a wearable device of a user is configured to temporarily disable a motion sensor device of the wearable device in a location where the user is likely to input secure information in accordance with various aspects of the present disclosure.

FIG. 6 (including FIGS. 6A to 6E) illustrates a scenario where a wearable device of a user is configured to temporarily disable a motion sensor device of the wearable device in response to a signal from a client device in accordance with various aspects of the present disclosure.

FIG. 7 (including FIGS. 7A to 7D) illustrates a scenario where a wearable device of a user is configured to temporarily disable a motion sensor device of the wearable device in response to a signal from a client device in accordance with various aspects of the present disclosure.

FIG. 8 is block diagram illustrating select components of an apparatus according to at least one example of the present disclosure.

FIG. 9 is a flowchart illustrating a method in accordance with various aspects of the present disclosure.

FIG. 10 is block diagram illustrating select components of an apparatus according to at least one example of the present disclosure.

FIG. 11 is a flowchart illustrating a method in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

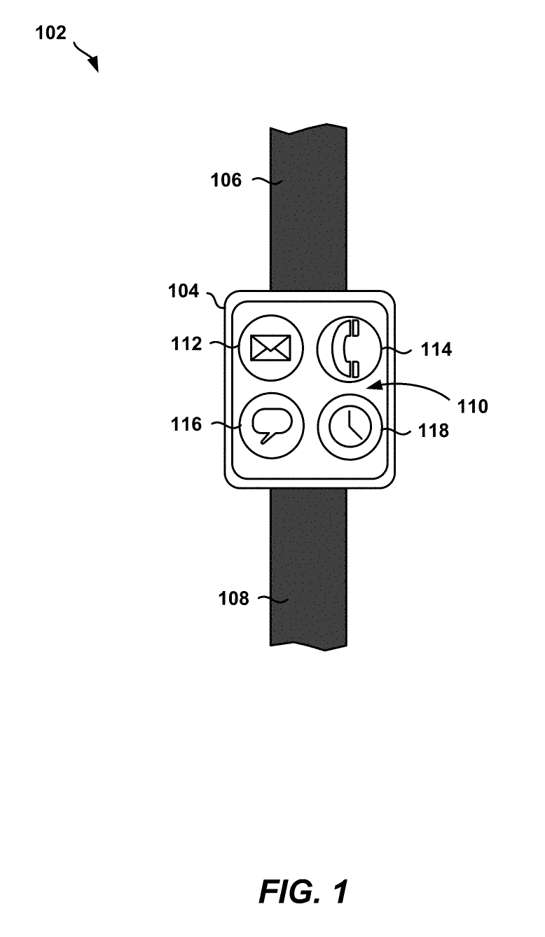

FIG. 1 illustrates an example of a conventional wearable device 102 (also referred to as a wearable computing device 102). In FIG. 1, the wearable device 102 is implemented as a smartwatch device for the sake of illustration. However, it should be understood that the wearable device 102 may be implemented as a different device, such as a fitness tracker, a media player, or other suitable type of wearable device.

As shown in FIG. 1, the wearable device 102 may include an electronic device housing 104 that is attached to a first strap portion 106 and a second strap portion 108. Accordingly, a user may attach the wearable device 102 to her person (e.g., to her wrist) using the first and second strap portions 106, 108. The electronic device housing 104 may include electronic components (not shown in FIG. 1), such as a central processing unit (CPU), memory, and other suitable components, that are configured to perform computing functions. Such computing functions may include running an operating system and/or execution of user applications. As shown in FIG. 1, the electronic device housing 104 may further include a touchscreen display 110 that allows a user to view information displayed by the wearable device 102, to input information to the wearable device 102, and/or to otherwise control the wearable device 102 (e.g., through gestures performed on the touchscreen display 110). As shown in FIG. 1, the wearable device 102 may display different icons on the touchscreen display 110 that correspond to different functions. For example, the wearable device 102 may display an email icon 112 associated with an email application, a telephone icon 114 associated with a telephone call application, a text message icon 116 associated with a text message application, and a clock icon 118 associated with a time display application. The wearable device 102 may support wireless networking technologies, such as Wi-Fi® and/or Bluetooth®, to access the Internet and/or to pair with other electronic devices (e.g., smartphones, laptop computers, etc.).

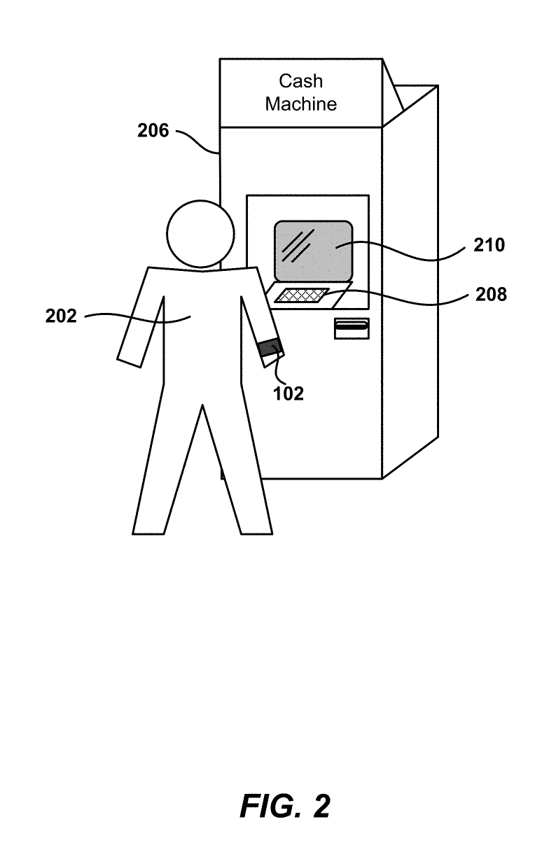

The electronic device housing 104 of the wearable device 102 may further include one or more sensors (not shown in FIG. 1) that can detect motion, such as an accelerometer device and/or a gyroscope device. In one example, the wearable device 102 may use such sensors for detecting whether the user of the wearable device 102 is moving for activity tracking applications. In another example, the wearable device 102 may use such sensors for detecting the orientation of the wearable device 102 to properly configure items being displayed on the touchscreen display 110 (e.g., for automatically displaying an image in a landscape orientation when the wearable device is rotated approximately 90 degrees). In some scenarios, however, sensor data output by the previously described sensors of the wearable device 102 may be accessed by unauthorized parties (e.g., hackers, cyber-attackers) to obtain secure information of the user (e.g., a personal identification number (PIN) associated with a user's bank account). An example of such scenario will be discussed below with respect to FIG. 2.

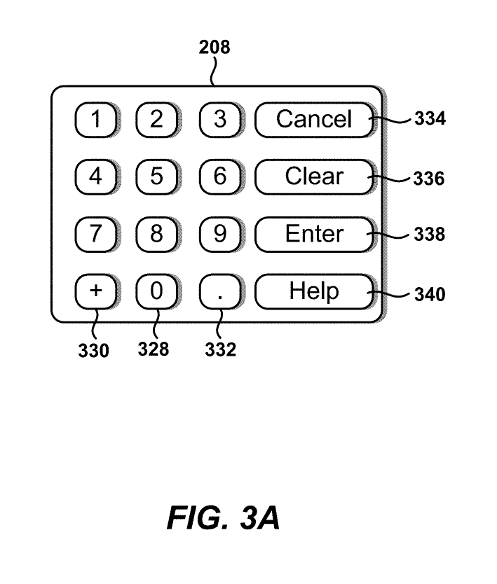

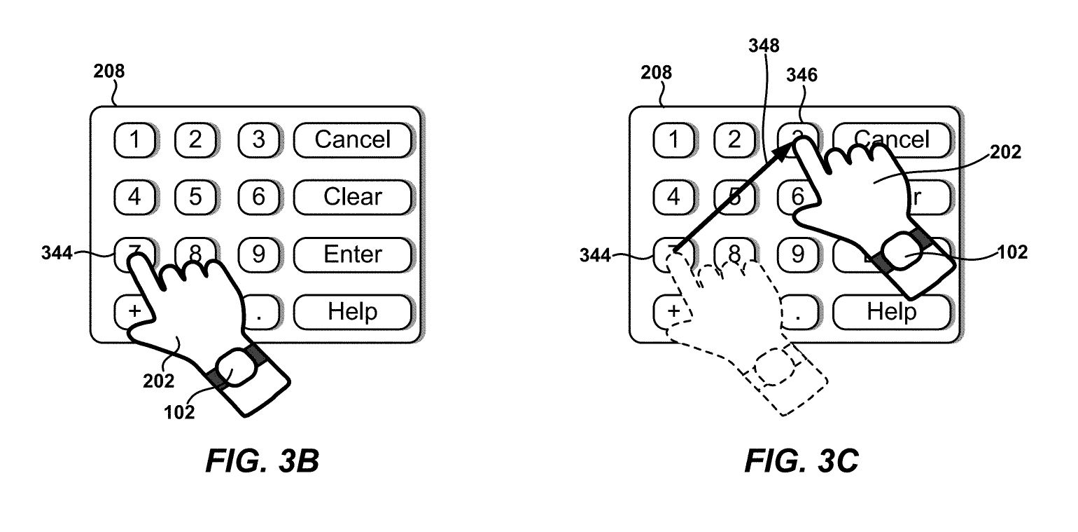

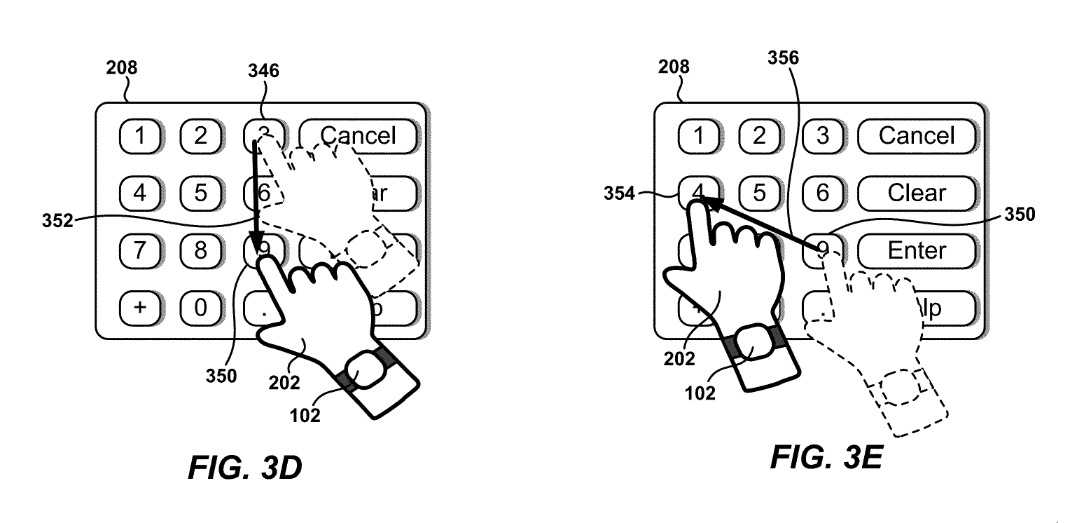

FIG. 2 illustrates an example scenario in which sensor data output from one or more sensors of the conventional wearable device 102 may be received by unauthorized parties to obtain secure information of a user. As shown in FIG. 2, a user 202 wearing the conventional wearable device 102 may approach a cash machine 206 (also referred to as an automated teller machine (ATM)) to withdraw cash from her bank account. The cash machine 206 may include a keypad 208 and a display 210. The keypad 208 may include a number of keys representing numbers, letters, symbols, operators, and/or commands. As described with reference to FIG. 3 (including FIGS. 3A to 3E) below, the user 202 may press the keys of the keypad 208 to input secure information (e.g., a PIN, user name, bank account information, etc.) in order to withdraw cash (or to perform any other suitable banking transactions).

As shown in FIG. 3A, the keypad 208 may include keys representing the numbers 0 to 9, such as the key 328 that represents the number 0. The keypad 208 may further include a key 332 representing a decimal point, a key 330 representing the addition symbol “+”, a key 334 representing a cancel operation command, a key 336 representing a clear command, a key 338 representing an enter command, and/or a key 340 representing a help request command. As shown in FIG. 3B, the user 202 wearing the conventional wearable device 102 may begin to input her PIN on the keypad 208 to gain access to her bank account. For example, if the PIN of the user 202 is the four digit string “7394”, the user 202 may press the key 344 representing the number 7. As shown in FIG. 3C, the user 202 may then move her hand (along with the wearable device 102) from the key 344 representing the number 7 to the key 346 representing the number 3 along the direction 348 and may press the key 346. As shown in FIG. 3D, the user 202 may move her hand (along with the wearable device 102) from the key 346 representing the number 3 to the key 350 representing the number 9 along the direction 352 and may press the key 350. Finally, as shown in FIG. 3E, the user 202 may move her hand (along with the wearable device 102) from the key 350 representing the number 9 to the key 354 representing the number 4 along the direction 356 and may press the key 354. Since the wearable device 102 may include one or more sensors that can detect motion as previously discussed, these sensors may output sensor data indicating that the user 202 moved her hand along the directions 348, 352, and 356. Unauthorized parties may receive and process such sensor data to determine the PIN (e.g., the four digit string “7394”) of the user 202.

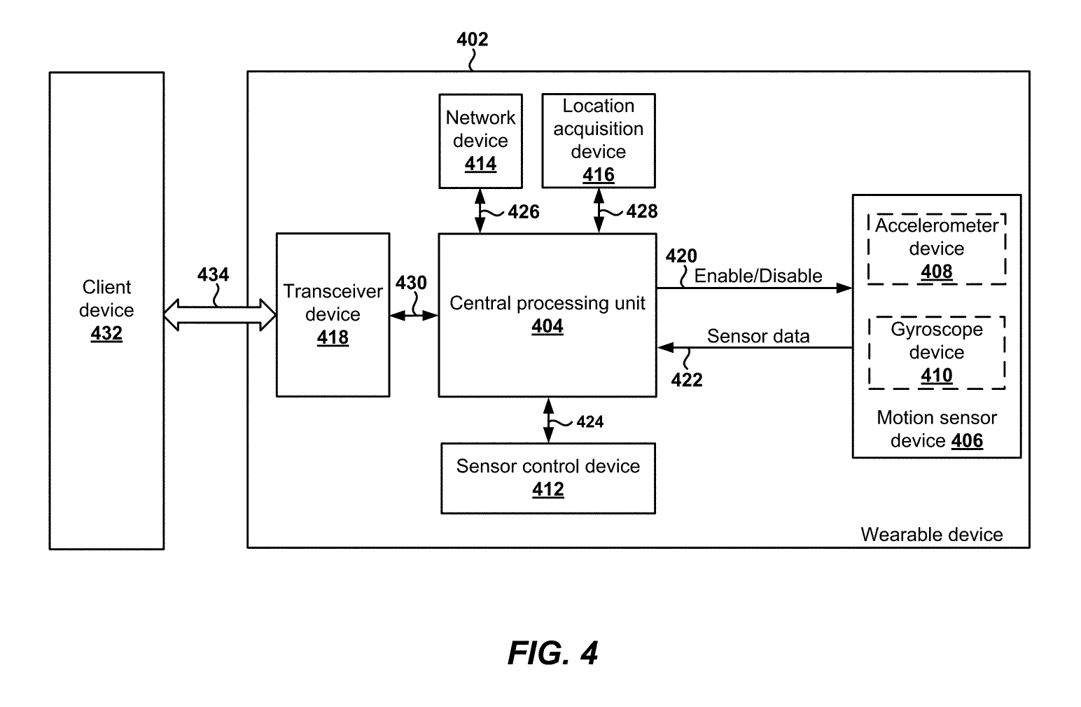

FIG. 4 illustrates a block diagram of an example wearable device 402 in accordance with various aspects of the present disclosure. The wearable device 402 may include a central processing unit (CPU) 404, a motion sensor device 406, a sensor control device 412, a network device 414, a location acquisition device 416, and a transceiver device 418. The motion sensor device 406 may include one or more sensor devices, such as an accelerometer device 408 and/or a gyroscope device 410. The motion sensor device 406 may output sensor data 422 to the CPU 404. The CPU 404 may process the sensor data 422 to determine if the wearable device 402 is moving or remaining stationary, to track the direction of movement of the wearable device 402, to determine the orientation and/or position of the wearable device 402 in a two-dimensional space or a three-dimensional space, and/or other suitable information. The CPU 404 may transmit an enable/disable signal 420 to the motion sensor device 406 that either enables (e.g., turns ON) the motion sensor device 406 or disables (e.g., turns OFF) the motion sensor device 406. In an aspect of the present disclosure, the enable/disable signal 420 may be configured to enable or disable some or all of the sensor devices that may be included in the motion sensor device 406. In an aspect of the present disclosure, the enable/disable signal 420 may be controlled by the sensor control device 412 as discussed in greater detail herein.

The network device 414 may be configured to support one or more wired and/or wireless networking technologies, such as Wi-Fi®, Bluetooth®, Long Term Evolution (LTE), 5G, and/or other suitable networking technologies. The network device 414 may be coupled to the CPU 404 via a signal path 426 (e.g., a bus). In an aspect of the present disclosure, the network device 414 may transmit and receive wireless signals through the transceiver device 418 using a wireless communication protocol (e.g., Bluetooth®) to communicate with other devices, such as the client device 432. For example, the client device 432 may be a smartphone, a laptop computer, or other type of device. Accordingly, in one example, the wearable device 402 may perform a pairing operation with the client device 432 to establish a connection 434 with the client device 432.

The location acquisition device 416 may be configured to determine the location of the wearable device 402. In one aspect, the location acquisition device 416 may be configured to receive and/or process Global Positioning System (GPS) signals to obtain the location of the wearable device 402 in terms of geographical coordinates. In another aspect, the location acquisition device 416 may be configured to support network assisted tracking methods. For example, the location acquisition device 416 may implement an observed time difference of arrival (OTDOA) feature by determining the time difference between specific signals from multiple network nodes (e.g., base stations, Evolved Node Bs) in a wide area network (WAN). The WAN, having knowledge of the locations of the multiple network nodes, may then determine the location of the wearable device 402 based on the time differences between the specific signals. The wearable device 402 may then obtain the determined location from the WAN.

### Sensor Control Based on Proximity to Secure Information Entry Points

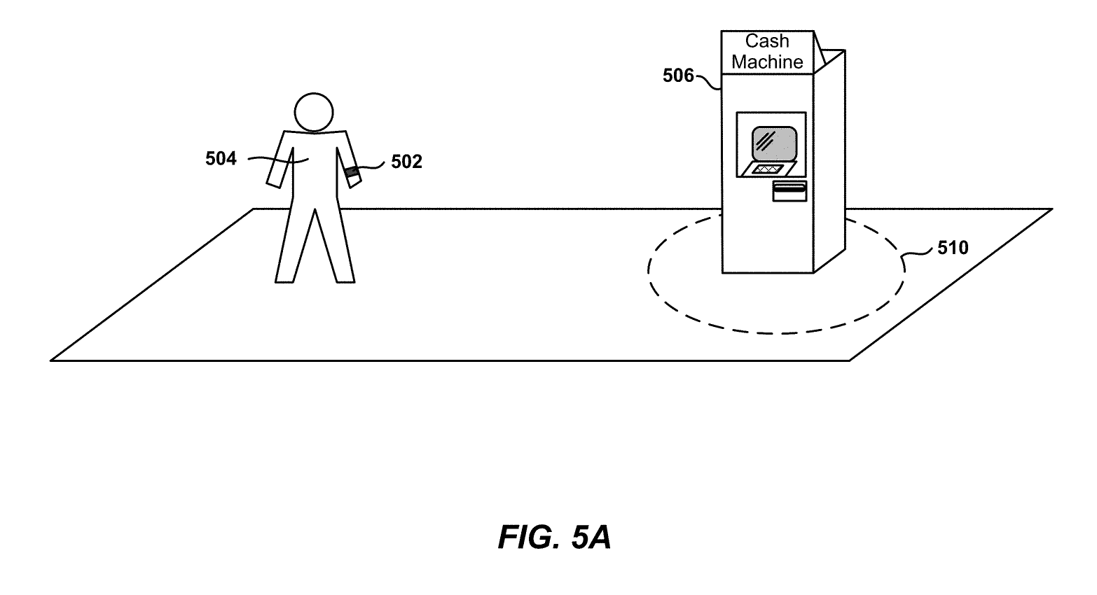

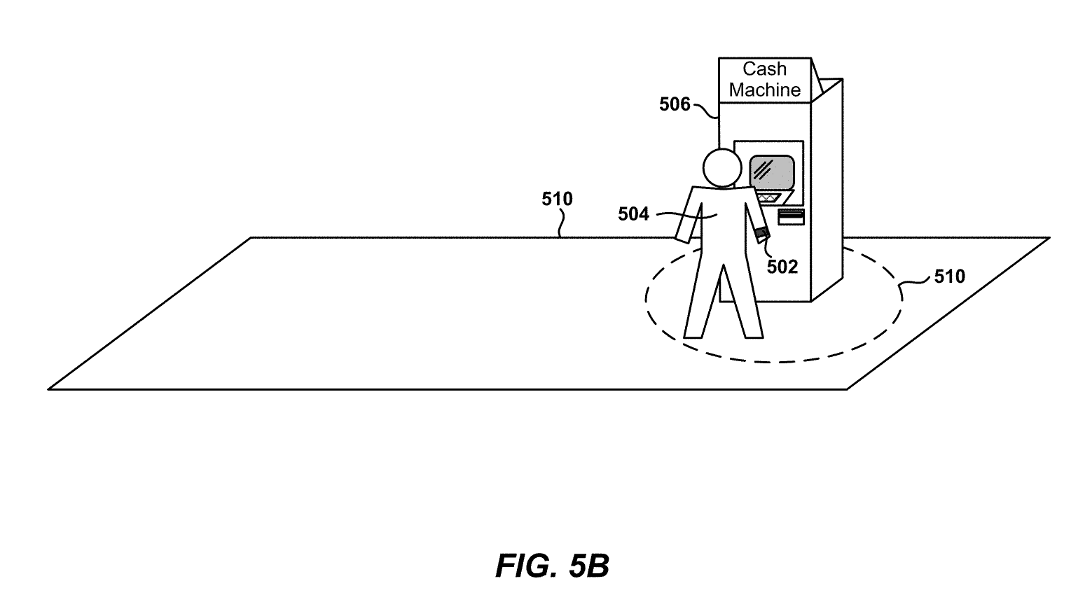

The previously described sensor control device 412 in the wearable device 402 may temporarily disable the motion sensor device 406 in circumstances where the user of the wearable device 402 is located proximate to a secure information entry point. For example, the secure information entry point may be a place where the user is likely to input secure information, such as a cash machine or a bank. By disabling the motion sensor device 406 in these circumstances, unauthorized parties may be effectively prevented from obtaining any sensor data that can be used to determine the secure information of the user. An example scenario is described below with respect to FIG. 5.

FIG. 5 (including FIG. 5A and FIG. 5B) illustrates a scenario where a wearable device 502 of a user 504 is configured to temporarily disable a motion sensor device of the wearable device 502 in a location where the user 504 is likely to input secure information in accordance with various aspects of the present disclosure. In an aspect, the wearable device 502 may correspond to the previously discussed wearable device 402 of FIG. 4. As shown in FIG. 5A, the user 504 equipped with the wearable device 502 may be approaching a cash machine 506 to withdraw cash (or to perform any other suitable banking transactions). In one aspect, the wearable device 502 may be configured to monitor the current location of the wearable device 502 (e.g., using GPS signals, an OTDOA feature, etc.) to determine whether the location of the wearable device 502 is within a region where the user 504 is likely to input secure information. In another aspect, a client device (e.g., the client device 432) carried by the user may monitor the current location (e.g., using GPS signals, an OTDOA feature, etc.) and may determine whether the current location is within a region where the user 504 is likely to input secure information. In such aspect, the client device may communicate the current location and/or whether the current location is within a region where the user 504 is likely to input secure information to the wearable device 502. In an aspect, a sensor control device (e.g., the sensor control device 412) in the wearable device 502 may be configured to store geographic coordinates of regions where the user 504 is likely to input secure information, such as regions proximate to cash machines, banking institutions, or other suitable places where the user 504 may input secure information. Therefore, since the wearable device 502 in FIG. 5A is outside of the region 510 that is proximate to the cash machine 506, the motion sensor device in the wearable device 502 may continue to be enabled by the sensor control device.

As shown in FIG. 5B, when the user 504 arrives at the cash machine 506, the wearable device 502 may determine that its current location is within a region (e.g., the region 510) that is proximate to where the user 504 is likely to input secure information. In an aspect, and as shown in FIG. 5B, the region 510 may be a circular perimeter that is defined around the cash machine 506. For example, the radius of the circular perimeter (e.g., the region 510) may represent a predetermined threshold distance. In such aspect, the wearable device 502 may determine that its current location is within the region 510 by determining the distance between its current location and each of a set of locations of secure data entry points stored at the wearable device 502. If the distance from the current location to any one of the set of locations of secure data entry points is less than the threshold distance, the sensor control device may determine that the wearable device 502 is within a region (e.g., the region 510) where the user 504 is likely to input secure information. Therefore, when the sensor control device of the wearable device 502 determines that the wearable device 502 is within a region (e.g., the region 510) where the user 504 is likely to input secure information, the sensor control device may temporarily disable the motion sensor device of the wearable device 502. For example, the previously described threshold distance may be five feet. In some aspects, the secure data entry point may be an entity other than a cash machine, such as a building (e.g., a bank) or other establishment where the user 504 is likely to input secure information.

When the user 504 completes the transaction at the cash machine 506 and/or is no longer within a region (e.g., region 510) where the user 504 is likely to input secure information, the sensor control device of the wearable device 502 may enable the motion sensor device of the wearable device 502.

### Sensor Control Based on Entry of Secure Information at a Client Device

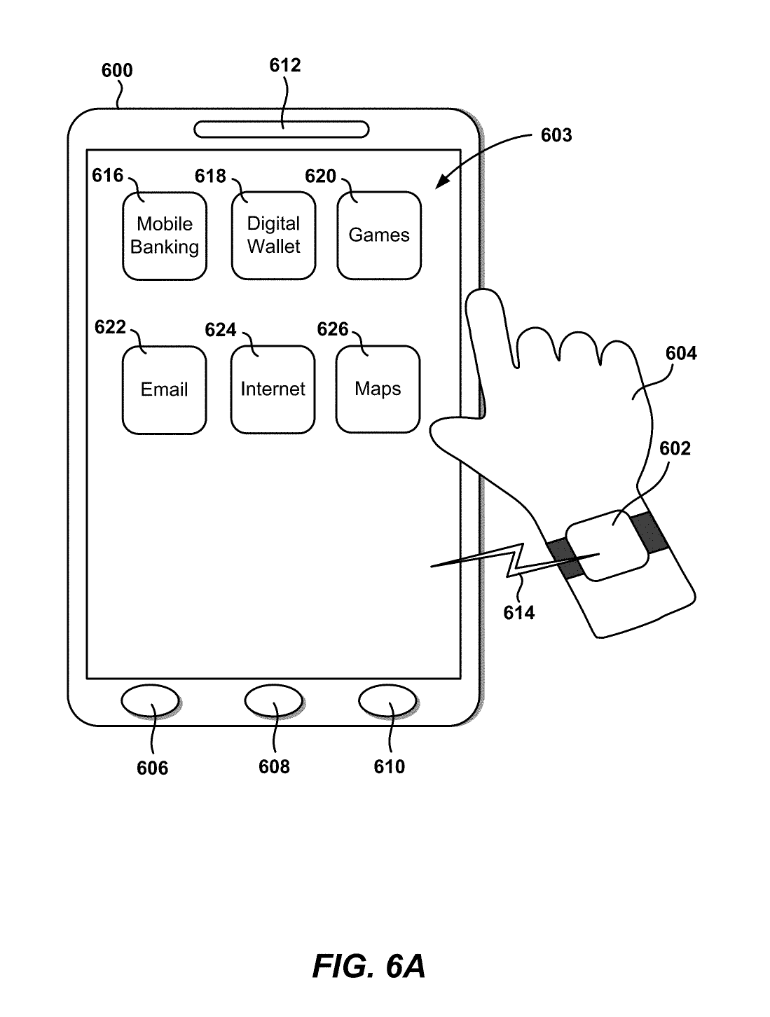

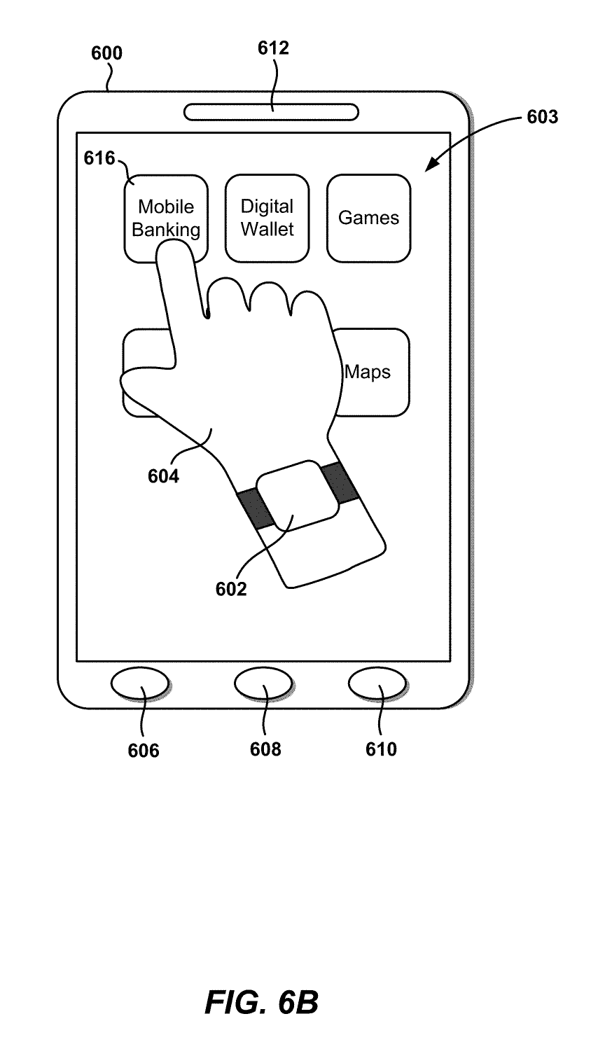

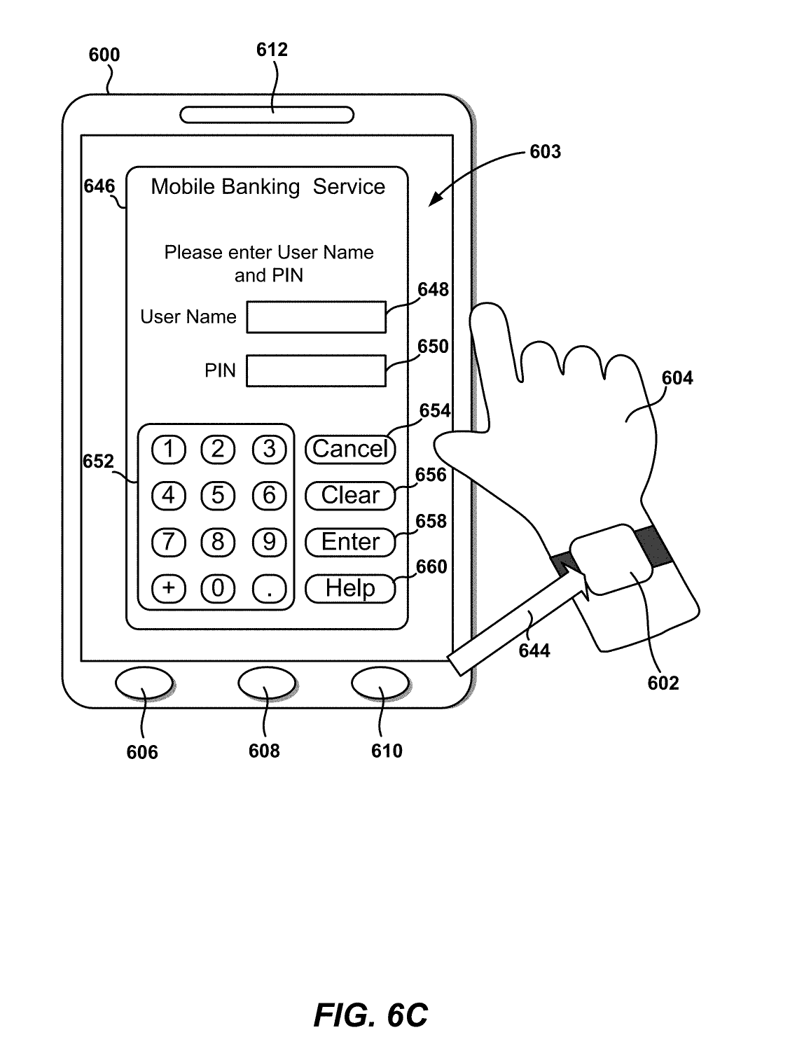

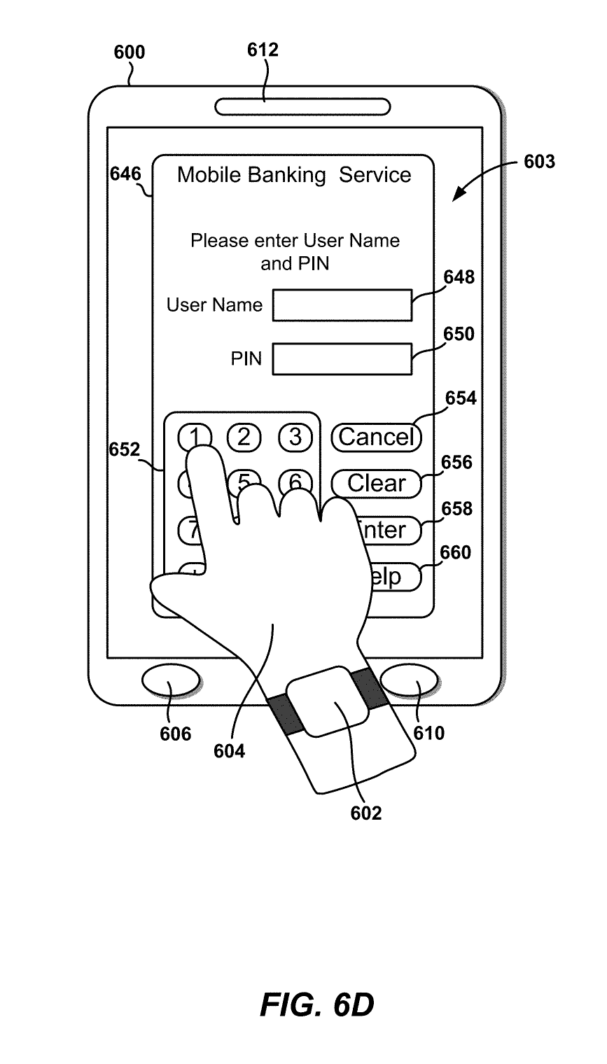

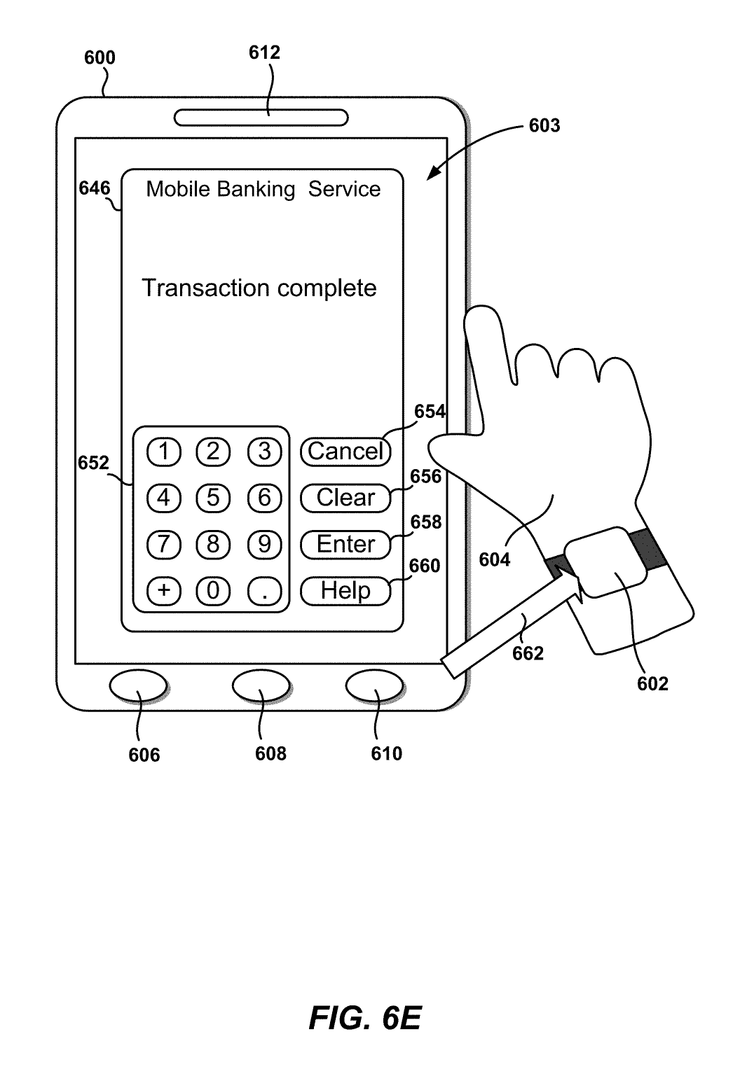

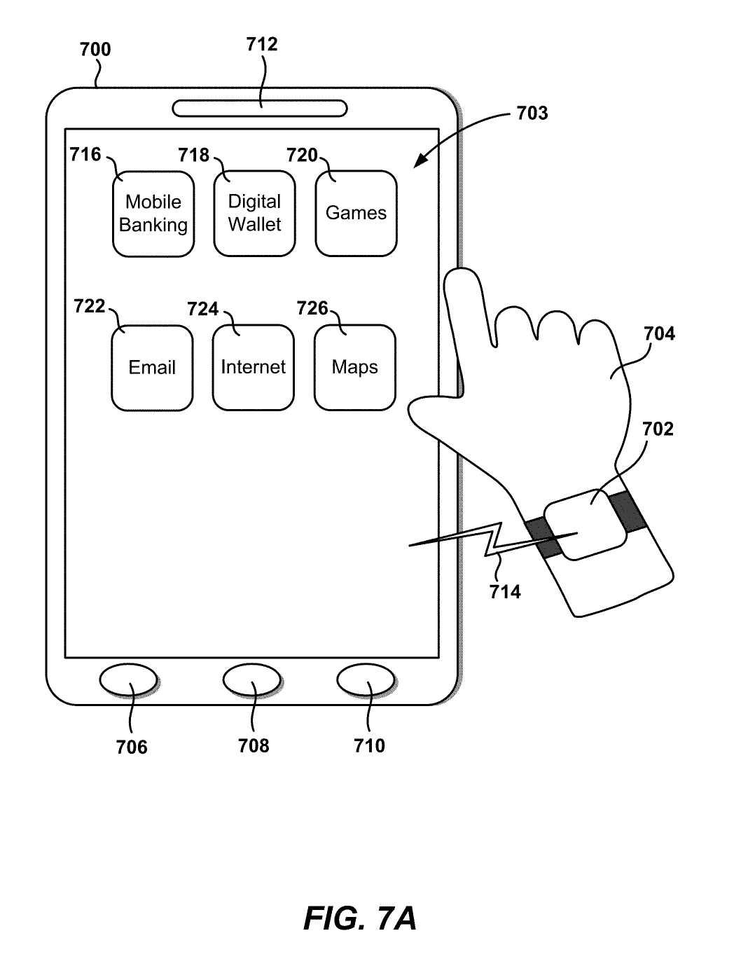

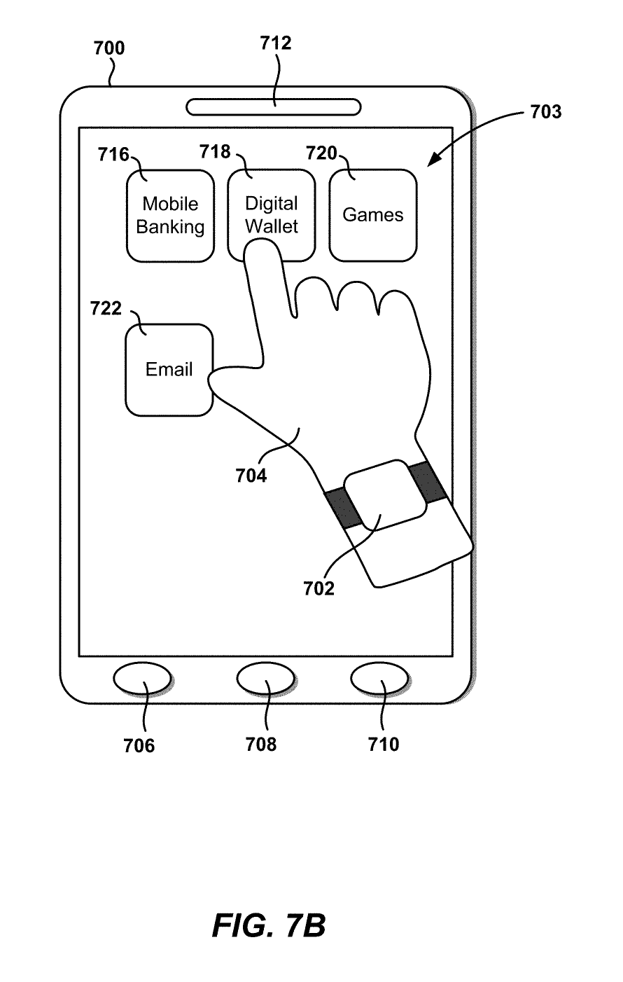

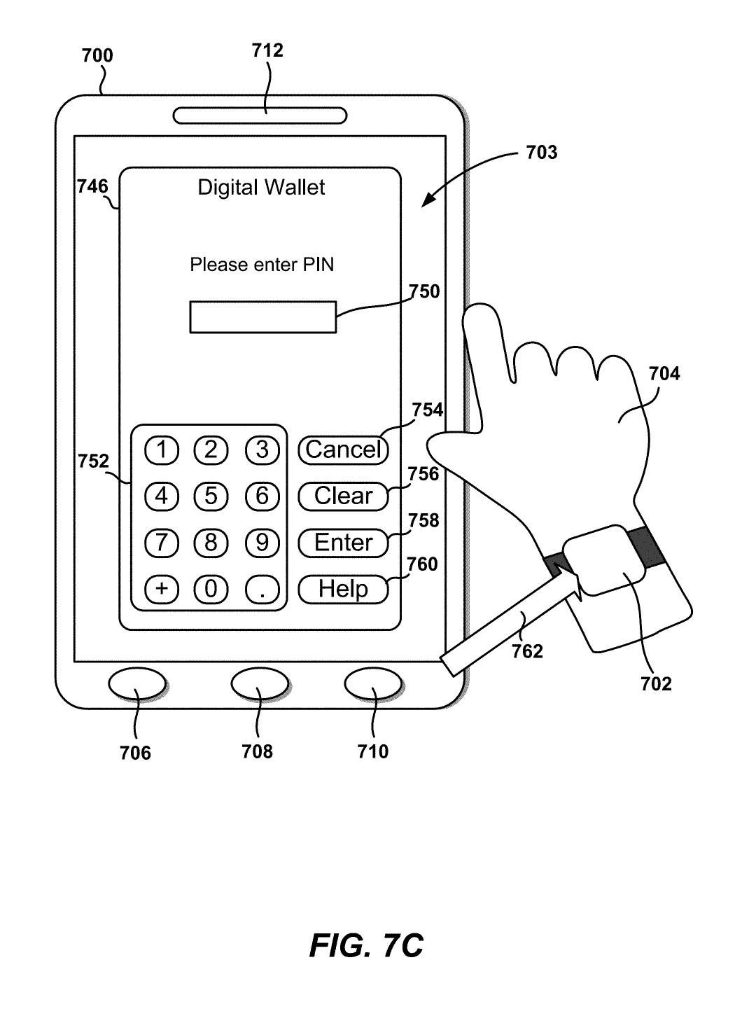

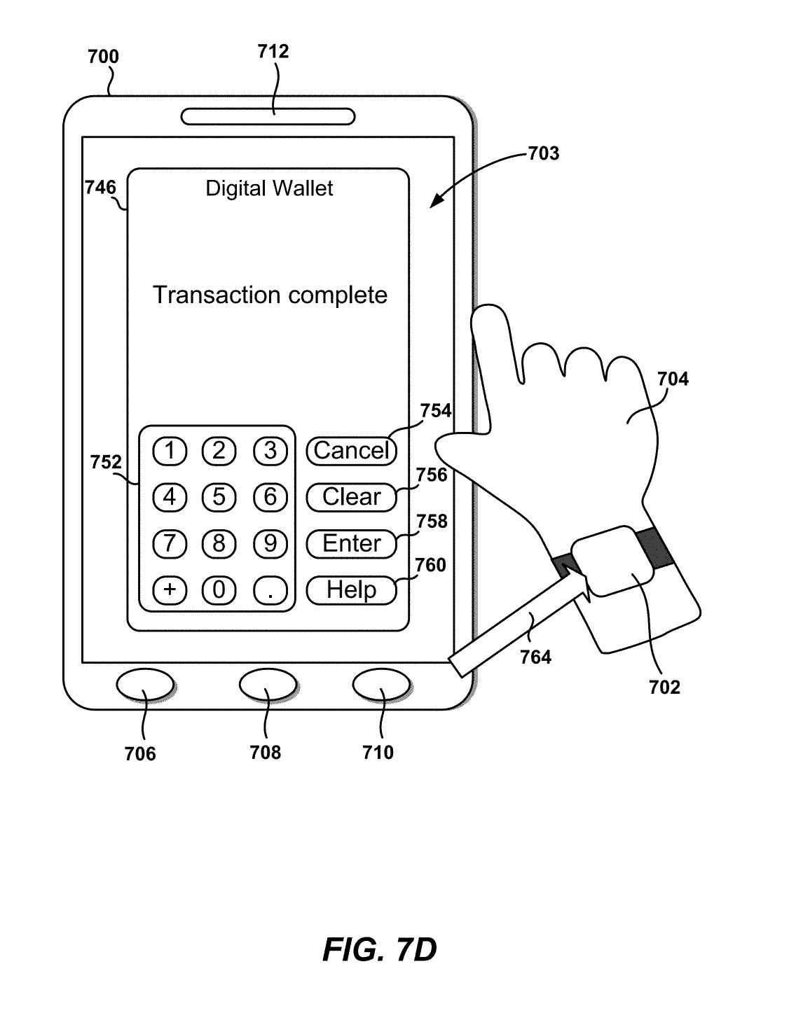

In an aspect of the present disclosure, when the previously described client device 432 determines that the user of the wearable device 402 may attempt to input secure information using an interface on the client device 432, the client device 432 may transmit a signal for disabling one or more sensors to the wearable device 402 through the connection 434. In such aspect, the signal may indicate to disable one or more sensors (e.g., an accelerometer device, a gyroscope device, etc.) that may be used to track hand motions of the user of the wearable device 402. The sensor control device 412 in the wearable device 402 may then temporarily disable the motion sensor device 406 (or a subset of the sensor devices that may be included in the motion sensor device 406) in response to the signal. By disabling the motion sensor device 406 in these circumstances, unauthorized parties may be effectively prevented from obtaining any sensor data that can be used to determine the secure information input by the user. Example scenarios are described below with respect to FIGS. 6 and 7.

FIG. 6 (including FIGS. 6A to 6E) illustrates a scenario where a wearable device 602 of a user 604 is configured to temporarily disable a motion sensor device of the wearable device 602 in response to a signal from a client device 600. In an aspect, the wearable device 602 may correspond to the previously discussed wearable device 402 of FIG. 4, and the client device 600 may correspond to the previously discussed client device 432 of FIG. 4. In the example of FIG. 6, the client device 600 is implemented as a smartphone for the sake of illustration.

As shown in FIG. 6A, the client device 600 may include a touchscreen display 603, a speaker 612, and physical buttons 606, 608, and 610. As further shown in FIG. 6A, the client device 600 may display various icons on the touchscreen display 603 that may allow a user to initiate different user applications. For example, the touchscreen display 603 may display a first icon 616 for initiating a mobile banking application, a second icon 618 for initiating a digital wallet application (also referred to an electronic wallet (e-wallet) application), a third icon 620 for initiating a gaming application, a fourth icon 622 for initiating an email application, a fifth icon 624 for initiating an Internet or Web browser application, and/or a sixth icon 626 for initiating a map application. In an aspect of the present disclosure, the wearable device 602 may perform a pairing operation with the client device 600 to establish a communication link 614. In such aspect, the communication link 614 may correspond to the connection 434 previously described with respect to FIG. 4. For example, the communication link 614 may be a wireless communication link, such as a Bluetooth® link.

As shown in FIG. 6B, the user 604 may tap on the first icon 616 to initiate a mobile banking application. For example, the mobile banking application may allow the user 604 to access one or more personal bank accounts and to conduct banking transactions (e.g., transferring funds, making payments, and other suitable transactions) through the client device 600.

As shown in FIG. 6C, the client device 600 may display an interface 646 for the mobile banking application on the touchscreen display 603. For example, the interface 646 may include a first field 648 for entering a user name of the user 604, a second field 650 for entering a PIN of the user 604, a virtual keypad 652, a virtual cancel command key 654, a virtual clear command key 656, a virtual enter key 658, and a virtual help key 660. Although the virtual keypad 652 in FIG. 6C is represented as a numeric keypad for ease of illustration, it should be understood that the virtual keypad 652 may also be represented as an alphanumeric keypad or a keypad including letters, characters, and/or symbols. Accordingly, the user 604 may need to input secure information, such as a user name and a PIN, using the virtual keypad 652 to gain access to her bank account.

In an aspect of the present disclosure, the client device 600 may be configured to detect the initiation of user applications that may involve secure transactions and/or an attempt to input secure information (e.g., a PIN, a username, a password, account information, etc.) by the user 604. For example, the client device 600 may be configured to detect that the initiation of a banking application may involve secure transactions and/or an attempt to input secure information by the user 604. In this aspect, the client device 600 may transmit a first signal 644 to the wearable device 602 for disabling one or more sensors of the wearable device 602 when a user application that may involve secure transactions and/or an attempt to input secure information by the user 604 has been initiated. In an aspect of the present disclosure, the first signal 644 may be transmitted through the communication link 614. In an aspect of the present disclosure, the first signal 644 may be a script that identifies one or more sensors (e.g., an accelerometer device, a gyroscope device, and/or any sensors that may be used to track the hand motions of the user 604) that should be disabled in the wearable device 602. Upon receiving the first signal 644 from the client device 600, the wearable device 602 may disable the one or more sensors identified in the first signal 644. In an aspect, the wearable device 602 may include a sensor control device (e.g., similar to the sensor control device 412 previously described with reference to FIG. 4) that may disable the one or more sensors identified in the first signal 644.

As shown in FIG. 6D, the user 604 may input the appropriate secure information through the virtual keypad 652 and may proceed with any secure transactions. Since the sensors in the wearable device 602 that may be used to track the hand motions of the user 604 have been disabled, unauthorized parties may be effectively prevented from obtaining any sensor data that can be used to determine the secure information of the user.

As shown in FIG. 6E, when the user 604 completes the mobile banking transaction on the client device 600 or terminates the mobile banking application on the client device 600, the client device 600 may transmit a second signal 662 to the wearable device 602 for enabling one or more sensors of the wearable device 602. In an aspect of the present disclosure, the second signal 662 may be transmitted through the communication link 614. In an aspect of the present disclosure, the second signal 662 may be a script that identifies one or more sensors (e.g., an accelerometer device, a gyroscope device, and/or any sensors that may be used to track the hand motions of the user 604) that should be enabled in the wearable device 602. Upon receiving the second signal 662 from the client device 600, the wearable device 602 may enable the one or more sensors identified in the second signal 662. In an aspect, the previously described sensor control device in the wearable device 602 may enable the one or more sensors identified in the second signal 662.

FIG. 7 (including FIGS. 7A to 7D) illustrates a scenario where a wearable device 702 of a user 704 is configured to temporarily disable a motion sensor device of the wearable device 702 in response to a signal from a client device 700. In an aspect, the wearable device 702 may correspond to the previously discussed wearable device 402 of FIG. 4, and the client device 700 may correspond to the previously discussed client device 432 of FIG. 4. In the example of FIG. 7, the client device 700 is implemented as a smartphone for the sake of illustration.

As shown in FIG. 7A, the client device 700 may include a touchscreen display 703, a speaker 712, and physical buttons 706, 708, and 710. As further shown in FIG. 7A, the client device 700 may display various icons on the touchscreen display 703 that may allow a user to initiate different user applications. For example, the touchscreen display 703 may display a first icon 716 for initiating a mobile banking application, a second icon 718 for initiating a digital wallet application, a third icon 720 for initiating a gaming application, a fourth icon 722 for initiating an email application, a fifth icon 724 for initiating an Internet or Web browser application, and/or a sixth icon 726 for initiating a map application. In an aspect of the present disclosure, the wearable device 702 may perform a pairing operation with the client device 700 to establish a communication link 714. In such aspect, the communication link 714 may correspond to the connection 434 previously described with respect to FIG. 4. For example, the communication link 714 may be a wireless communication link, such as a Bluetooth® link.

As shown in FIG. 7B, the user 704 may tap on the second icon 718 to initiate a digital wallet application. In one aspect, the digital wallet application may allow the user 704 to purchase items at a store through an electronic transaction. In another aspect, the digital wallet application may allow the user 704 to use the client device 700 as a smart card to withdraw cash from a cash machine. In such aspect, the client device 700 together with the digital wallet application may serve as a debit card to withdraw cash from a card-free cash machine, for example.

As shown in FIG. 7C, the client device 700 may display an interface 746 for the digital wallet application on the touchscreen display 703. For example, the interface 746 may include a field 750 for entering a PIN of the user 704, a virtual keypad 752, a virtual cancel command key 754, a virtual clear command key 756, a virtual enter key 758, and a virtual help key 760. Although the virtual keypad 752 in FIG. 7C is represented as a numeric keypad for ease of illustration, it should be understood that the virtual keypad 752 may also be represented as an alphanumeric keypad or a keypad including letters, characters, and/or symbols. Accordingly, the user 704 may need to input secure information, such as a PIN, using the virtual keypad 752 to conduct a digital wallet transaction.

In an aspect of the present disclosure, the client device 700 may be configured to detect the initiation of user applications that may involve secure transactions and/or an attempt to input secure information (e.g., a PIN) by the user 704. For example, the client device 700 may be configured to detect that the initiation of the digital wallet application may involve secure transactions and/or an attempt to input secure information by the user 704. In this aspect, the client device 700 may transmit a first signal 762 to the wearable device 702 for disabling one or more sensors of the wearable device 702 when the digital wallet application is initiated. In an aspect of the present disclosure, the first signal 762 may be transmitted through the communication link 714. In an aspect of the present disclosure, the first signal 762 may be a script that identifies one or more sensors (e.g., an accelerometer device, a gyroscope device, and/or any sensors that may be used to track hand motions of the user 704) that should be disabled in the wearable device 702. Upon receiving the first signal 762 from the client device 700, the wearable device 702 may disable the one or more sensors identified in the first signal 762. In an aspect, the wearable device 702 may include a sensor control device (e.g., similar to the sensor control device 412 previously described with reference to FIG. 4) that may disable the one or more sensors identified in the first signal 762. The user 604 may input the appropriate secure information through the virtual keypad 752 and may proceed with any secure transactions. Since the sensors in the wearable device 702 that may be used to track hand motions of the user 704 have been disabled, unauthorized parties may be effectively prevented from obtaining any sensor data that can be used to determine the secure information of the user.

As shown in FIG. 7D, when the user 704 completes the digital wallet transaction on the client device 700 or terminates the digital wallet application on the client device 700, the client device 700 may transmit a second signal 764 to the wearable device 702 for enabling one or more sensors of the wearable device 702. In an aspect of the present disclosure, the second signal 764 may be transmitted through the communication link 714. In an aspect of the present disclosure, the second signal 764 may be a script that identifies one or more sensors (e.g., an accelerometer device, a gyroscope device, and/or any sensors that may be used to track hand motions of the user 704) that should be enabled in the wearable device 702. Upon receiving the second signal 764 from the client device 700, the wearable device 702 may enable the one or more sensors identified in the second signal 764. In an aspect, the previously described sensor control device in the wearable device 702 may enable the one or more sensors identified in the second signal 764.

### First Exemplary Device and Method

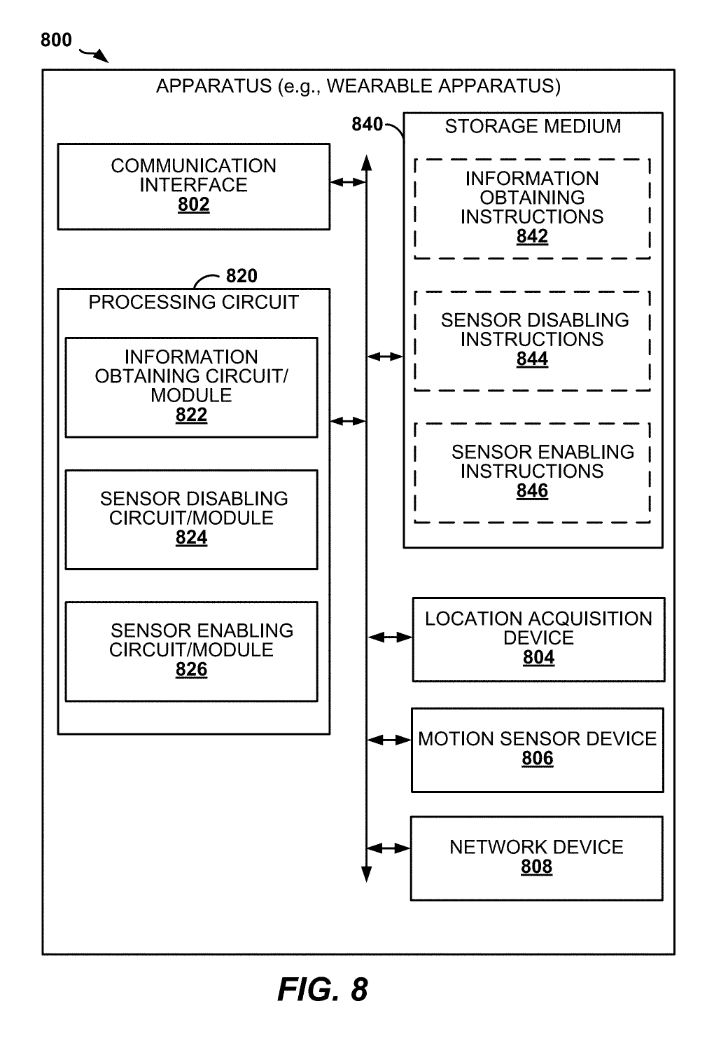

FIG. 8 is block diagram illustrating select components of an apparatus 800 in accordance with various aspects of the disclosure. In some aspects, the apparatus 800 may be a wearable device (also referred to as a wearable apparatus), such as the wearable device 402, 502, 602, and/or 702 as previously described. The apparatus 800 includes a communication interface 802, a location acquisition device 804, a motion sensor device 806, a network device 808, a storage medium 840, and a processing circuit 820. The processing circuit 820 is coupled to or placed in electrical communication with each of the communication interface 802, the location acquisition device 804, the motion sensor device 806, the network device 808, and the storage medium 840. The communication interface 802 may include, for example, circuitry to support wired or wireless communications (e.g., Wi-Fi®, Bluetooth®, LTE, 5G, etc.). In an aspect, the communication interface 802 may include one or more of: signal driver circuits, signal receiver circuits, amplifiers, signal filters, signal buffers, or other circuitry used to interface with a signaling bus or other types of signaling media.

The processing circuit 820 is arranged to obtain, process and/or send data, control data access and storage, issue commands, and control other desired operations. The processing circuit 820 may include circuitry adapted to implement desired programming provided by appropriate media in at least one example. In some instances, the processing circuit 820 may include circuitry adapted to perform a desired function, with or without implementing programming. By way of example, the processing circuit 820 may be implemented as one or more processors, one or more controllers, and/or other structure configured to execute executable programming and/or perform a desired function. Examples of the processing circuit 820 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 820 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 820 are for illustration and other suitable configurations within the scope of the disclosure are also contemplated.

The processing circuit 820 is adapted for processing, including the execution of programming, which may be stored on the storage medium 840. As used herein, the terms “programming” or “instructions” shall be construed broadly to include without limitation instruction sets, instructions, code, code segments, program code, programs, programming, subprograms, software modules, applications, software applications, software packages, routines, subroutines, objects, executables, threads of execution, procedures, functions, etc., whether referred to as software, firmware, middleware, microcode, hardware description language, or otherwise.

In some instances, the processing circuit 820 may include one or more of: an information obtaining circuit/module 822, a sensor disabling circuit/module 824, and a sensor enabling circuit/module 826.

The information obtaining circuit/module 822 may include circuitry and/or instructions (e.g., the information obtaining instructions 842 stored on the storage medium 840) adapted to obtain information indicating that a user of the wearable apparatus is to input secure information.

The sensor disabling circuit/module 824 may include circuitry and/or instructions (e.g., the sensor disabling instructions 844 stored on the storage medium 840) adapted to disable, in response to the obtained information, one or more sensors of the wearable device that are capable of tracking hand movements of the user.

The sensor enabling circuit/module 826 may include circuitry and/or instructions (e.g., the sensor enabling instructions 846 stored on the storage medium 840) adapted to enable the one or more sensors of the wearable apparatus when the user has completed the input of the secure information, when the user is no longer proximate to a secure data entry point, or when a signal indicating to enable the one or more sensors of the wearable apparatus is received from a client apparatus.

The storage medium 840 may represent one or more processor-readable devices for storing programming, electronic data, databases, or other digital information. The storage medium 840 may also be used for storing data that is manipulated by the processing circuit 820 when executing programming. The storage medium 840 may be any available media that can be accessed by the processing circuit 820, including portable or fixed storage devices, optical storage devices, and various other mediums capable of storing, containing and/or carrying programming. By way of example and not limitation, the storage medium 840 may include a processor-readable storage medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other mediums for storing programming, as well as any combination thereof. Thus, in some implementations, the storage medium may be a non-transitory (e.g., tangible) storage medium.

The storage medium 840 may be coupled to the processing circuit 820 such that the processing circuit 820 can read information from, and write information to, the storage medium 840. That is, the storage medium 840 can be coupled to the processing circuit 820 so that the storage medium 840 is at least accessible by the processing circuit 820, including examples where the storage medium 840 is integral to the processing circuit 820 and/or examples where the storage medium 840 is separate from the processing circuit 820.

Programming/instructions stored by the storage medium 840, when executed by the processing circuit 820, causes the processing circuit 820 to perform one or more of the various functions and/or process steps described herein. For example, the storage medium 840 may include one or more of: information obtaining instructions 842, sensor disabling instructions 844, sensor enabling instructions 846. Thus, according to one or more aspects of the disclosure, the processing circuit 820 is adapted to perform (in conjunction with the storage medium 840) any or all of the processes, functions, steps and/or routines for any or all of the apparatuses described herein. As used herein, the term “adapted” in relation to the processing circuit 820 may refer to the processing circuit 820 being one or more of configured, employed, implemented, and/or programmed (in conjunction with the storage medium 840) to perform a particular process, function, step and/or routine according to various features described herein.

The location acquisition device 804 may be configured to receive and/or process Global Positioning System (GPS) signals to obtain the location of the apparatus 800 in terms of geographical coordinates. In another aspect, the location acquisition device 804 may be configured to support network assisted tracking methods (e.g., OTDOA). The motion sensor device 806 may include one or more sensors that are capable of tracking hand movements of a user, such as an accelerometer device and/or a gyroscope device. The network device 808 may include, for example, circuitry to support wired or wireless network communication protocols (e.g., Wi-Fi®, Bluetooth®, LTE, 5G, etc.).

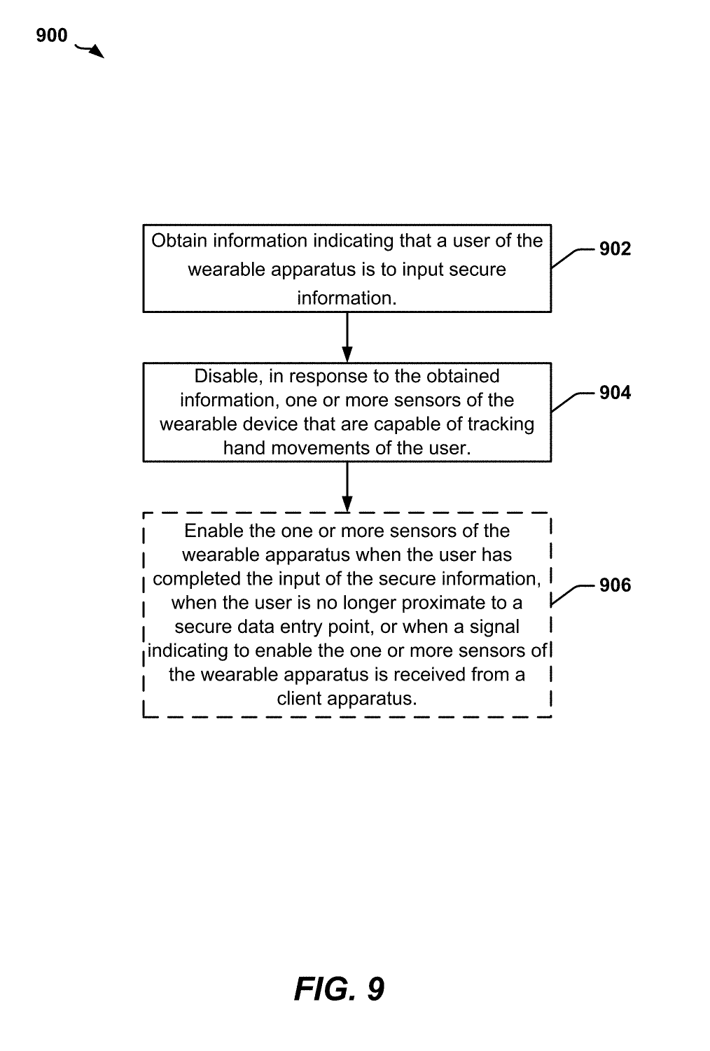

With the above in mind, examples of operations according to the disclosed aspects will be described in more detail in conjunction with the flowchart of FIG. 9. For convenience, the operations of FIG. 9 (or any other operations discussed or taught herein) may be described as being performed by specific components. It should be appreciated, however, that in various implementations these operations may be performed by other types of components and may be performed using a different number of components. It also should be appreciated that one or more of the operations described herein may not be employed in a given implementation.

FIG. 9 is a flowchart 900 illustrating a method for an apparatus. It should be understood that the operations in FIG. 9 represented with dashed lines represent optional operations. The wearable apparatus obtains information indicating that a user of the wearable apparatus is to input secure information 902. The wearable apparatus disables, in response to the obtained information, one or more sensors of the wearable device that are capable of tracking hand movements of the user 904. For example, the one or more sensors of the wearable device may include at least one of an accelerometer device or a gyroscope device. The wearable apparatus enables the one or more sensors of the wearable apparatus when the user has completed the input of the secure information, when the user is no longer proximate to a secure data entry point, or when a signal indicating to enable the one or more sensors of the wearable apparatus is received from a client apparatus 906. For example, the client apparatus may be an electronic device (e.g., a smartphone, laptop computer, etc.) that is in communication with the wearable apparatus and that includes an interface for entry of the secure information by the user.

In an aspect, the wearable apparatus obtains information indicating that a user of the wearable apparatus is to input secure information by obtaining a location of the user and determining whether the location of the user is proximate to a secure data entry point. In such aspect, the one or more sensors of the wearable apparatus are disabled when the location of the user is proximate to the secure data entry point. For example, the wearable apparatus may determine whether the location of the user is proximate to the secure data entry point by obtaining a distance between the location of the user and each of a set of locations of secure data entry points stored at the wearable apparatus, and determining that the location of the user is proximate to the secure data entry point when the distance is less than a threshold value. For example, the threshold vale may be five feet.

In an aspect, the wearable apparatus obtains information indicating that a user of the wearable apparatus is to input secure information by receiving a signal from a client apparatus when the user attempts to input the secure information through an interface on the client apparatus. In such aspect, the signal indicates to disable the one or more sensors of the wearable apparatus. As described herein, disabling the one or more sensors of the wearable device prevents the one or more sensors from generating sensor data that indicates the hand movements of the user during entry of the secure information. In an aspect, the signal from the client apparatus is received in response to an initiation of a mobile banking application or a digital wallet application on the client apparatus. In some aspects, the signal from the client device is received when the user is no longer proximate to a secure data entry point.

In an aspect, the wearable apparatus obtains information indicating that a user of the wearable apparatus is to input secure information by receiving a signal from a client apparatus indicating that the user of the wearable apparatus is to input secure information.

### Second Exemplary Device and Method

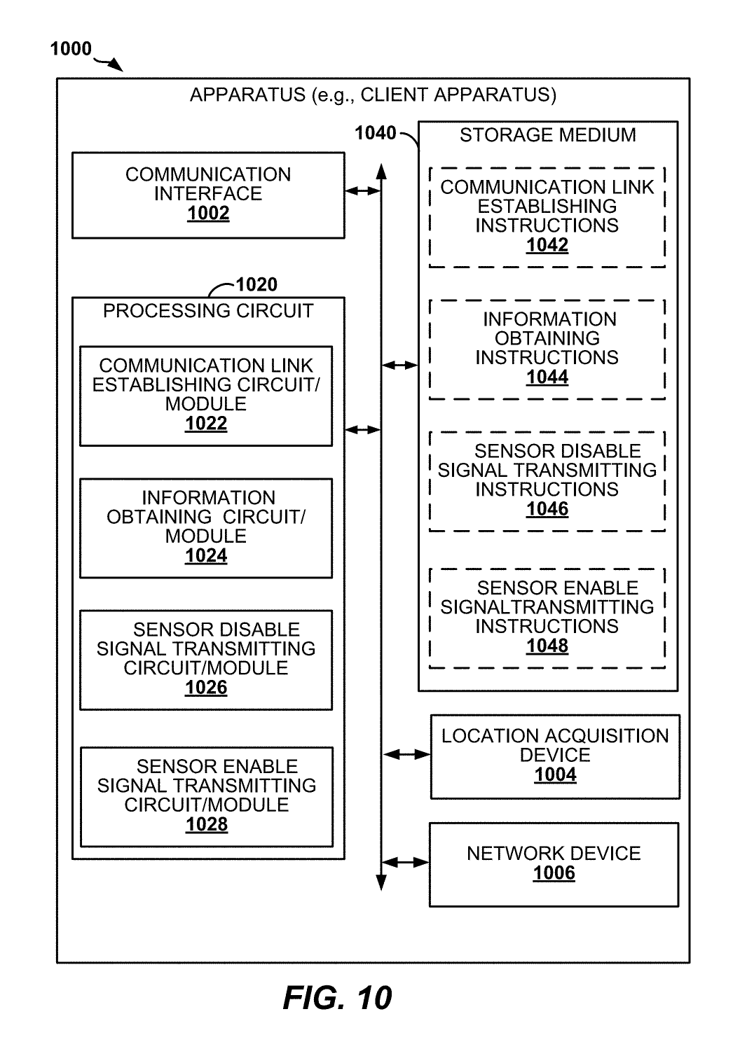

FIG. 10 is block diagram illustrating select components of an apparatus 1000 in accordance with various aspects of the disclosure. In some aspects, the apparatus 1000 may be a client device (also referred to as a client apparatus), such as the client device 432, 600, and/or 700 as previously described. The apparatus 1000 includes a communication interface 1002, a location acquisition device 1004, a network device 1006, a storage medium 1040, and a processing circuit 1020. The processing circuit 1020 is coupled to or placed in electrical communication with each of the communication interface 1002, the location acquisition device 1004, the network device 1006, and the storage medium 1040. The communication interface 1002 may include, for example, circuitry to support wired or wireless communications (e.g., Wi-Fi®, Bluetooth®, LTE, 5G, etc.). In an aspect, the communication interface 1002 may include one or more of: signal driver circuits, signal receiver circuits, amplifiers, signal filters, signal buffers, or other circuitry used to interface with a signaling bus or other types of signaling media.

The processing circuit 1020 is arranged to obtain, process and/or send data, control data access and storage, issue commands, and control other desired operations. The processing circuit 1020 may include circuitry adapted to implement desired programming provided by appropriate media in at least one example. In some instances, the processing circuit 1020 may include circuitry adapted to perform a desired function, with or without implementing programming. By way of example, the processing circuit 1020 may be implemented as one or more processors, one or more controllers, and/or other structure configured to execute executable programming and/or perform a desired function. Examples of the processing circuit 1020 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 1020 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 1020 are for illustration and other suitable configurations within the scope of the disclosure are also contemplated.

The processing circuit 1020 is adapted for processing, including the execution of programming, which may be stored on the storage medium 1040. As used herein, the terms “programming” or “instructions” shall be construed broadly to include without limitation instruction sets, instructions, code, code segments, program code, programs, programming, subprograms, software modules, applications, software applications, software packages, routines, subroutines, objects, executables, threads of execution, procedures, functions, etc., whether referred to as software, firmware, middleware, microcode, hardware description language, or otherwise.

In some instances, the processing circuit 1020 may include one or more of: a communication link establishing circuit/module 1022, an information obtaining circuit/module 1024, a sensor disable signal transmitting circuit/module 1026, and a sensor enable signal transmitting circuit/module 1028.

The communication link establishing circuit/module 1022 may include circuitry and/or instructions (e.g., the communication link establishing instructions 1042 stored on the storage medium 1040) adapted to establish a communication link with a wearable apparatus.

The information obtaining circuit/module 1024 may include circuitry and/or instructions (e.g., the information obtaining instructions 1044 stored on the storage medium 1040) adapted to obtain information indicating that a user of the wearable apparatus is to input secure information through an interface on the client apparatus.

The sensor disable signal transmitting circuit/module 1026 may include circuitry and/or instructions (e.g., the sensor disable signal transmitting instructions 1046 stored on the storage medium 1040) adapted to transmit a signal to the wearable apparatus that indicates to disable the one or more sensors of the wearable apparatus that are capable of tracking hand movements of the user.

The sensor enable signal transmitting circuit/module 1028 may include circuitry and/or instructions (e.g., the sensor enable signal transmitting instructions 1048 stored on the storage medium 1040) adapted to transmit a signal to the wearable apparatus indicating to enable the one or more sensors of the wearable apparatus when the user has completed the input of the secure information or when one or more secure transactions have been completed.

The storage medium 1040 may represent one or more processor-readable devices for storing programming, electronic data, databases, or other digital information. The storage medium 1040 may also be used for storing data that is manipulated by the processing circuit 1020 when executing programming. The storage medium 1040 may be any available media that can be accessed by the processing circuit 1020, including portable or fixed storage devices, optical storage devices, and various other mediums capable of storing, containing and/or carrying programming. By way of example and not limitation, the storage medium 1040 may include a processor-readable storage medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other mediums for storing programming, as well as any combination thereof. Thus, in some implementations, the storage medium may be a non-transitory (e.g., tangible) storage medium.

The storage medium 1040 may be coupled to the processing circuit 1020 such that the processing circuit 1020 can read information from, and write information to, the storage medium 1040. That is, the storage medium 1040 can be coupled to the processing circuit 1020 so that the storage medium 1040 is at least accessible by the processing circuit 1020, including examples where the storage medium 1040 is integral to the processing circuit 1020 and/or examples where the storage medium 1040 is separate from the processing circuit 1020.

Programming/instructions stored by the storage medium 1040, when executed by the processing circuit 1020, causes the processing circuit 1020 to perform one or more of the various functions and/or process steps described herein. For example, the storage medium 1040 may include one or more of: communication link establishing instructions 1042, information obtaining instructions 1044, sensor disable signal transmitting instructions 1046, sensor enable signal transmitting instructions 1048. Thus, according to one or more aspects of the disclosure, the processing circuit 1020 is adapted to perform (in conjunction with the storage medium 1040) any or all of the processes, functions, steps and/or routines for any or all of the apparatuses described herein. As used herein, the term “adapted” in relation to the processing circuit 1020 may refer to the processing circuit 1020 being one or more of configured, employed, implemented, and/or programmed (in conjunction with the storage medium 1040) to perform a particular process, function, step and/or routine according to various features described herein.

The location acquisition device 1004 may be configured to receive and/or process Global Positioning System (GPS) signals to obtain the location of the apparatus 1000 in terms of geographical coordinates. In another aspect, the location acquisition device 1004 may be configured to support network assisted tracking methods (e.g., OTDOA). The network device 1006 may include, for example, circuitry to support wired or wireless network communication protocols (e.g., Wi-Fi®, Bluetooth®, LTE, 5G, etc.).

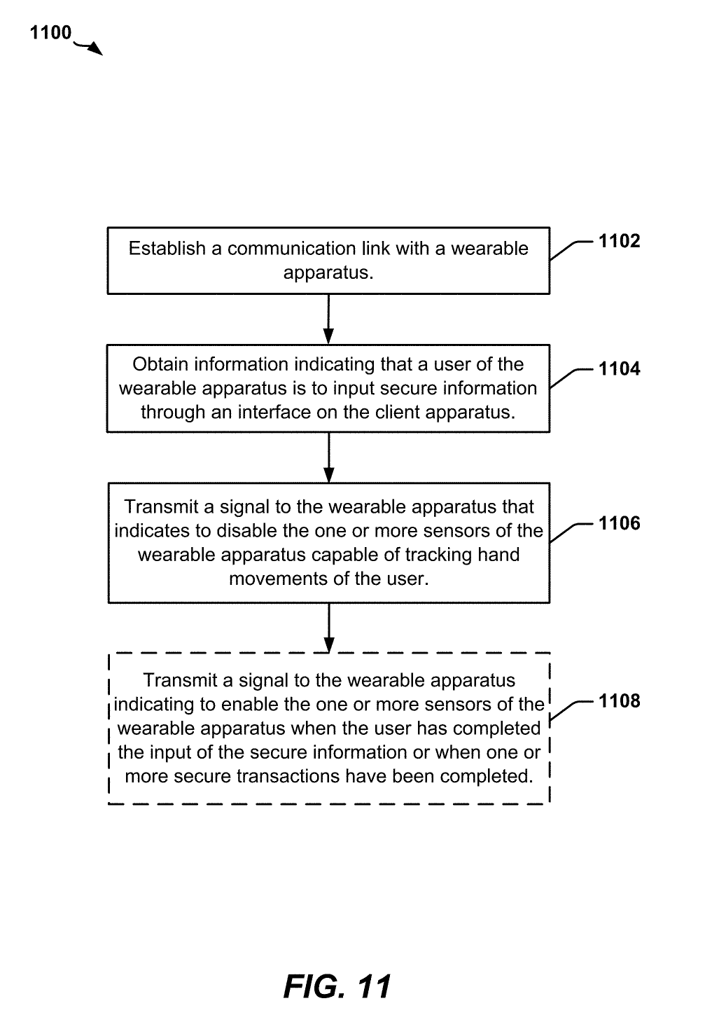

With the above in mind, examples of operations according to the disclosed aspects will be described in more detail in conjunction with the flowchart of FIG. 11. For convenience, the operations of FIG. 11 (or any other operations discussed or taught herein) may be described as being performed by specific components. It should be appreciated, however, that in various implementations these operations may be performed by other types of components and may be performed using a different number of components. It also should be appreciated that one or more of the operations described herein may not be employed in a given implementation.

FIG. 11 is a flowchart 1100 illustrating a method for an apparatus (e.g., a client apparatus). It should be understood that the operations in FIG. 11 represented with dashed lines represent optional operations.

The client apparatus establishes a communication link with a wearable apparatus 1102. The client apparatus obtains information indicating that a user of the wearable apparatus is to input secure information through an interface on the client apparatus 1104. The client apparatus transmits a signal to the wearable apparatus that indicates to disable the one or more sensors of the wearable apparatus capable of tracking hand movements of the user 1106. The client apparatus transmits a signal to the wearable apparatus indicating to enable the one or more sensors of the wearable apparatus when the user has completed the input of the secure information, or when one or more secure transactions have been completed 1108.

In an aspect, the client apparatus obtains the information indicating that the user of the wearable apparatus is to input the secure information through the interface on the client apparatus by detecting an initiation of a mobile banking application or a digital wallet application at the client apparatus.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein. Additional elements, components, steps, and/or functions may also be added or not utilized without departing from the disclosure.

While features of the disclosure may have been discussed relative to certain implementations and figures, all implementations of the disclosure can include one or more of the advantageous features discussed herein. In other words, while one or more implementations may have been discussed as having certain advantageous features, one or more of such features may also be used in accordance with any of the various implementations discussed herein. In similar fashion, while exemplary implementations may have been discussed herein as device, system, or method implementations, it should be understood that such exemplary implementations can be implemented in various devices, systems, and methods.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. In some aspects, a process may correspond to a method, a function, a procedure, a subroutine, a subprogram, etc. When a process corresponds to a function, its termination corresponds to a return of the function to the calling function or the main function. One or more of the various methods described herein may be partially or fully implemented by programming (e.g., instructions and/or data) that may be stored in a machine-readable, computer-readable, and/or processor-readable storage medium, and executed by one or more processors, machines and/or devices.

Those of skill in the art would further appreciate that the various illustrative logical blocks, modules, circuits, and algorithm steps described in connection with the implementations disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

Within the disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first die may be coupled to a second die in a package even though the first die is never directly physically in contact with the second die. The terms “circuit” and “circuitry” are used broadly, and intended to include both hardware implementations of electrical devices and conductors that, when connected and configured, enable the performance of the functions described in the disclosure, without limitation as to the type of electronic circuits, as well as software implementations of information and instructions that, when executed by a processor, enable the performance of the functions described in the disclosure.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like. As used herein, the term “obtaining” may include one or more actions including, but not limited to, receiving, generating, determining, or any combination thereof.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A method for a wearable apparatus comprising:
obtaining information indicating that a user of the wearable apparatus is to input secure information; and
disabling, in response to the obtained information, one or more sensors of the wearable apparatus that are capable of tracking hand movements of the user.

2. The method of claim 1, wherein the obtaining the information comprises:
obtaining a location of the user; and
determining whether the location of the user is proximate to a secure data entry point,
wherein the one or more sensors of the wearable apparatus are disabled when the location of the user is proximate to the secure data entry point.

3. The method of claim 2, wherein the determining whether the location of the user is proximate to the secure data entry point comprises:
obtaining a distance between the location of the user and each of a set of locations of secure data entry points stored at the wearable apparatus; and
determining that the location of the user is proximate to the secure data entry point when the distance is less than a threshold value.

4. The method of claim 1, wherein the obtaining the information comprises:
receiving a signal from a client apparatus when the user attempts to input the secure information through an interface on the client apparatus, wherein the signal indicates to disable the one or more sensors of the wearable apparatus.

5. The method of claim 4, wherein the signal from the client apparatus is received in response to an initiation of a mobile banking application or a digital wallet application on the client apparatus.

6. The method of claim 1, wherein the obtaining the information comprises:
receiving a signal from a client apparatus indicating that the user of the wearable apparatus is to input secure information.

7. The method of claim 1, further comprising:
enabling the one or more sensors of the wearable apparatus when the user has completed the input of the secure information, when the user is no longer proximate to a secure data entry point, or when a signal indicating to enable the one or more sensors of the wearable apparatus is received from a client apparatus.

8. The method of claim 1, wherein the one or more sensors of the wearable apparatus includes at least one of an accelerometer device or a gyroscope device.

9. The method of claim 4, wherein the client apparatus is a portable electronic device that is in communication with the wearable apparatus and that includes an interface for entry of the secure information by the user.

10. The method of claim 1, wherein the disabling the one or more sensors of the wearable apparatus prevents the one or more sensors from generating sensor data indicating the hand movements of the user during entry of the secure information.

11. An apparatus comprising:
a communication interface to communicate with a client apparatus; and
a processing circuit coupled to the communication interface, the processing circuit configured to:
obtain information indicating that a user of the apparatus is to input secure information; and
disable, in response to the obtained information, one or more sensors of the apparatus capable of tracking hand movements of the user.

12. The apparatus of claim 11, wherein the processing circuit configured to obtain information indicating that the user of the apparatus is to input secure information is further configured to:
obtain a location of the user; and
determine whether the location of the user is proximate to a secure data entry point,
wherein the one or more sensors of the apparatus are disabled when the location of the user is proximate to the secure data entry point.

13. The apparatus of claim 11, wherein the processing circuit configured to obtain information indicating that the user of the apparatus is to input secure information is further configured to:
receive a signal from the client apparatus when the user attempts to input the secure information through an interface on the client apparatus, wherein the signal indicates to disable the one or more sensors of the apparatus.

14. The apparatus of claim 13, wherein the signal from the client apparatus is received in response to an initiation of a mobile banking application or a digital wallet application at the client apparatus.

15. The apparatus of claim 11, wherein the processing circuit configured to obtain information indicating that the user of the apparatus is to input secure information is further configured to:
receive a signal from the client apparatus indicating that the user of the apparatus is to input secure information.

16. The apparatus of claim 11, wherein the disabling the one or more sensors of the apparatus prevents the one or more sensors from generating sensor data that indicates the hand movements of the user during entry of the secure information.

17. The apparatus of claim 11, wherein the processing circuit is further configured to:
enable the one or more sensors of the apparatus when the user has completed the input of the secure information, when the user is no longer proximate to a secure data entry point, or when a signal indicating to enable the one or more sensors of the apparatus is received from the client apparatus.

18. A method for a client apparatus comprising:
establishing a communication link with a wearable apparatus;
obtaining information indicating that a user of the wearable apparatus is to input secure information through an interface on the client apparatus; and
transmitting a signal to the wearable apparatus that indicates to disable one or more sensors of the wearable apparatus capable of tracking hand movements of the user.

19. The method of claim 18, wherein the obtaining the information indicating that the user of the wearable apparatus is to input the secure information through the interface on the client apparatus comprises:
detecting an initiation of a mobile banking application or a digital wallet application at the client apparatus.

20. The method of claim 18, further comprising:
transmitting a signal to the wearable apparatus indicating to enable the one or more sensors of the wearable apparatus when the user has completed the input of the secure information or when one or more secure transactions have been completed.
